(19) United States
(12) Patent Application Publication
(10) Pub. No.: US 2025/0109058 A1
(43) Pub. Date: Apr. 3, 2025

(54) GLASS FABRICATION USING PHOSPHATE FOR VARIETY OF OPTICAL APPLICATIONS

(71) Applicants: El Sayed YOUSEF, Abha (SA); Mohammed S. ALQAHTANI, Abha (SA); A. M. ALSHEHRI, Abha (SA); Bozena BURTAN-GWIZDALA, Cracow (PL); Manuela REBEN, Cracow (PL)

(72) Inventors: El Sayed YOUSEF, Abha (SA); Mohammed S. ALQAHTANI, Abha (SA); A. M. ALSHEHRI, Abha (SA); Bozena BURTAN-GWIZDALA, Cracow (PL); Manuela REBEN, Cracow (PL)

(21) Appl. No.: 18/898,094

(22) Filed: Sep. 26, 2024

(30) Foreign Application Priority Data
Sep. 29, 2023 (IN) 202341065476

(51) Int. Cl. C03C 3/16

(52) U.S. Cl. CPC C03C 3/16

(57) ABSTRACT

The present disclosure describes the phosphate glass with telluride material has a composition of P₂O₅:TeO₂:BaF₂:ZnO:LiCl and contains Nb₂O₅:CdO:Ag₂O with transition oxide NiO:CuO:MnO₂ dopant ions of a rare earth metal La₂O₃:Tm₂O₃:Eu₂O₃. The thermal, optical, and luminescence properties of the fabricated glasses were investigated. The fabricated glasses are with high-quality, some of this fabricated glasses allows using in bandpass filters in the UV and VIS region especially red, and also fabricated glasses doped with rare earth ions RE uses in solid lasers, optical amplifiers, and optical coherence tomography (OCT). The fabricated glasses has low OH, homogenous, and the luminescence performance is good. The fabricated glasses co-doped Tm₂O₃/Eu₂O₃ led to the enchantment of the optical telecommunication band broadband NIR photo luminescence emission. Moreover, the fabricated glasses doped with Mn₂O₃/Ag₂O/Pr₂O₃, Eu₂O₃/Tm₂O₃ is superior's materials for wideband near-infrared phosphors which candidate for LED-based light sources and optical fiber application at 0.45 and 1.84 μm.

### FIELD OF INVENTION

The present invention relates to a glass fabrication using Phosphate for variety of optical applications more specifically, to a method for manufacturing glasses using rare earth oxide and transition metals Mn₂O₃/Ag₂O/Pr₂O₃/Eu₂O₃/Tm₂O₃ doped and co-doped with the phosphate glasses based on the technical field of glass technology use in the luminescent, optical filter, laser glass and optical fiber amplification system.

### BACKGROUND OF THE INVENTION

The background description includes basic of the field of invention including a study of recent technologies along with a few patent literatures that may be useful in understanding the present invention. It is previously known that phosphate glass compositions are referred to as photonic glasses in a number of articles and patent documents.

Low cost, a wide variety of compositions, simple manufacturing methods, and the ability to produce in a variety of shapes and sizes; such as; rods, discs, and thin films are a few of the many benefits of glasses. In addition, phosphate glasses have been shown to be superior for use in fiber optics and lasers over the past few decades due to the occurrence of both wide absorption and emission bands with adequate stimulated emission cross-sections (σₑₘ) and gain coefficients with rare-earth (RE) ions doping. Also, the phosphate glasses have been shown to be an ideal product in fiber lasers and optical amplifiers due to its high thermal stability, high flexibility, and high mechanical strength. Bilel Charfi et. al Materials 2022, 15, 6518, studied the enhancement of optical telecommunication Bands for Pr³⁺-doped halide phosphate glasses display broadband NIR photoluminescence.

The PO₄ tetrahedron acts as the fundamental unit of structure in phosphate glass. Phosphate (P) is a pentavalent ion, one oxygen removed from the tetrahedron's neutrality. As a result, the PO₄ tetrahedrons only have connections at their three corners. Phosphate glass is different from silica-based glass in this respect. The softening temperature of phosphate glasses is often lower than that of silicate glasses because of the substantial amount of nonbridging oxygen present in them. In addition, the high concentration of nonbridging oxygen in phosphate glass allows multiple locations for rare earth ions. It causes rare earth ions to be highly soluble. The modifier influences the glass network, decreasing its melting point and increasing the number of rare earth ion sites. For a high gain per unit length, a homogeneous dispersion of rare earth ions in the glass is essential. The network's strength and chemical toughness are increased by the intermediator by bridging a component of the network's linkages without significantly changing the melting temperature. Moreover, TeO₄ tetrahedral form the structural basis of tellurite glass. A conditional glass network former is TeO₂. When TeO₂ is combined with one or more appropriate oxides, such as ZnO, WO₃, PbO, ZnO, Y₂O₃, B₂O₃, Al₂O₃ and La₂O₃, glass will be created. TeO₂ cannot produce glass on its own. Depending on the particular glass composition and the ion's doping, the Te⁴⁺ ion can display in a detailed, four- or six-coordinated structure. In this instant, a few patent literatures have discussed herein.

The first US Patent literature holding the U.S. Pat. No. 4,940,677 (Beall et al.) has described in brief the disclosed glasses exhibiting transition temperatures below 450° C., consisting in mole percent ZnO (23-55%), P₂O₅ (28-40%), and R₂O (10-35%), wherein R₂O consists of at least two alkali metal oxides selected from the group of Li₂O (0-25%), Na₂O (0-25%), and K₂O (0-25%). The thermal expansion and hardness characteristics, as well as an absence of chemical durability or stability, make the phosphate laser glasses of various compositions unsuitable for the laser applications Hence, the cited prior art is different from the present invention, because it does not disclose about the essential features as claimed in the present invention which is more advantageous in these aspects. Further, next cited patent literature is described hereinbelow.

The optical constant for laser fluorophosphates glasses were reported U.S. Pat. Nos. 2,511,225; 2,511,227; 2,481,700 and 2,430,539. Divalent manganese ions play an important role as active centers in inorganic phosphors, mainly for lighting applications. The glasses doped with MnO exhibit two pronounced bands at 409 and at 493 nm which correspond to electronic d-d transitions of the Mn²⁺ and Mn³⁺ ions, respectively.

The optical bandpass filters based on absorption of transition metal (V, Cr, Mn, Fe, Co, Ni and Cu) or rare earth ions doped phosphate glasses usually have intense absorption in visible and near infra-red region.

### OBJECTS OF THE INVENTION

The principal object of the invention is to provide a high quality glasses which can be used in bandpass filters, in the UV and VIS region especially red, and also as glass doped with rare earth ions RE used in solid lasers, optical amplifiers and optical coherence tomography (OCT).

Said and other objects of the present disclosure will be apparent to a person skilled in the art after consideration of the following summary of subject matter as claimed, detailed description taken into consideration with accompanying drawings in which preferred embodiments of the present disclosure are illustrated.

### SUMMARY OF INVENTION

The object of the invention is achieved by a phosphate glass with telluride material which has a composition of P₂O₅:TeO₂:BaF₂:ZnO:LiCl and contains Nb₂O₅:CdO:Ag₂O with transition oxide NiO:CuO:MnO₂ dopant ions of a rare earth metal La₂O₃:Tm₂O₃:Eu₂O₃.

A fabricated glass comprising Phosphorus pentoxide by weight of composition 40 percentage; Barium fluoride by weight of composition ranging from 25-35 percentage; Zinc Oxide by weight of composition ranging from 10-20 percentage; and remaining in additive selected from the group of Manganese dioxide, Silver oxide, Praseodymium oxide, Niobium pentoxide, Tellurium dioxide, Lanthanum (III) oxide, Copper (II) oxide, Nickel oxide, Lithium Chloride, Cadmium oxide, Europium (III) oxide, and Thulium (III) oxide.

The produced glass has low OH, homogenous and the luminescence performance is good. The produced glasses are codoped with Tm₂O₃/Eu₂O₃ which led to the enchantment of the optical telecommunication band broadband NIR photoluminescence emission. Moreover, the synthesized glasses doped with Mn₂O₃/Ag₂O/Pr₂O₃, Eu₂O₃/Tm₂O₃ are superior's materials for wideband near-infrared phosphors which candidate for LED-based light sources and optical fiber application at 0.45 and 1.84 μm. The novel phosphate glasses fabricated are used in various photonic application strongly depend on the composition.

According to another embodiment of the proposed invention is that the fabricated glasses doped with transition metals (Ni and Cu) are found to be used in the new optical filter applications.

According to yet another embodiment of the proposed invention is that the fabricated glasses doped with CuO (MP4) is used in optical filter application in VIS and IR range; the fabricated glasses with composition 40P₂O₅-25ZnO-15BaF₂-15TeO₂-2Nb₂O₅-2CuO-1.0La₂O₃ as superior material has wide absorbance broad band from 500 to 2400 nm.

According to one embodiment of the proposed invention is that the fabricated glasses doped with NiO (MP5) within composition 40P₂O₅-25ZnO-15BaF₂-15TeO₂-2Nb₂O₅-2NiO-1.0La₂O₃ are used as optical filter at 430 and 830 nm.

According to one embodiment of the proposed invention is that the fabricated glasses doped with MnO (MP1) exhibit bands at 500 nm which attributed to electronic d-d transitions of Mn³⁺ ions.

According to another embodiment of the proposed invention is that the fabricated glasses (MP3) with composition 40P₂O₅-25ZnO-15BaF₂-15TeO₂-4.0Nb₂O₅-1.0La₂O₃ has plasmonic (nanoparticle) corresponding at 540 nm.

According to said embodiment of the present invention is that the fabricated glasses within composition 40P₂O₅-30ZnO-10BaF₂-18LiCl-2.0CdO-35000 ppm Tm₂O₃-35000 ppm Eu₂O₃ has high thermal stability and lowest growth rate of nucleation process.

According to the embodiment of the present invention, the fabricated glasses with composition 40P₂O₅-30ZnO-10BaF₂-18LiCl-2.0CdO has highest optical energy gap is a superior media for doping by rare earth ions to get solid laser source.

According to the another embodiment of the present invention, the fabricated glasses with composition 40P₂O₅-30ZnO-10BaF₂-18LiCl-2.0CdO-35000 ppm Eu₂O₃ and 40P₂O₅-30ZnO-10BaF₂-18LiCl-2.0CdO-35000 ppm Tm₂O₃-35000 ppm Eu₂O₃, has high intense brightness orangish red fluorescence which demonstrates the superiority of laser glasses as lighting source.

According to the yet another embodiment of the present invention, the fabricated glasses with the composition 40P₂O₅-35ZnO-20BaF₂-3MnO₂-2.0Ag₂O-15000 ppm Pr₂O₃ emits NIR PL, will obtain that ultra broadband with FWHM=186 nm, which will be suitable in fabrication of optical fibre amplification systems.

According to the one embodiment of the present invention, the fabricated glasses within composition 40P₂O₅-30ZnO-10BaF₂-18LiCl-2.0CdO-35000 ppm Tm₂O₃ is used for 0.45 laser and 1.42, 1.45 and 1.46 μm fiber amplifier.

The concepts are further described below in the detailed description. This summary is not intended to identify key features or essential features of the claimed subject matter, nor is it intended to be used to limit the scope of the claimed subject matter.

To further understand the characteristics and technical contents along with technical advantages and exemplary data of the present disclosure, a description relating thereto will be made with reference to the accompanying drawings. However, the drawings are illustrative only but not used to limit the scope of the present subject matter.

### BRIEF DESCRIPTION OF DRAWINGS

It is to be noted, however, that the appended drawings illustrate only typical embodiments of the present subject matter and are therefore not to be considered for limiting of its scope, for the invention may admit to other equally effective embodiments. The detailed description is described with reference to the accompanying figures. In the figures, a reference number identifies the figure in the reference number first appears. The same numbers are used throughout the figures to reference like features and components. Some embodiments of system or method or structure in accordance with embodiments of the present subject matter are now described, by way of example, and with reference to the accompanying figures, in which:

FIG. 1 (a) illustrates DTA profile of produced glasses with different compositions and embodiments.

FIG. 1 (b) illustrates DTA profile of produced glasses with different compositions and embodiments.

FIG. 2 illustrates Vis-UV-NIR absorption spectra of first embodiment (MP1).

FIG. 3 illustrates Vis-UV-NIR absorption spectra of second embodiment (MP2).

FIG. 4 illustrates Vis-UV-NIR absorption spectra of third embodiment (MP3).

FIG. 5 illustrates Vis-UV-NIR absorption spectra of fourth embodiment MP4.

FIG. 6 illustrates Vis-UV-NIR absorption spectra of fifth embodiment MP5.

FIG. 7 illustrates Vis-UV-NIR absorption spectra of sixth embodiment MP6.

FIG. 8 illustrates Vis-UV-NIR absorption spectra of seventh embodiment MP7.

FIG. 9 illustrates Vis-UV-NIR absorption spectra of eighth embodiment MP8.

FIG. 10 illustrates Relation between (hav)^{0.5} vs. ha of MP1 glasses (as an example).

FIG. 11 illustrates VIS-PL emission spectra of glass MP2 under excitation 445 nm.

FIG. 12 illustrates NIR-PL emission spectra of glass MP2 under excitation 445 nm.

FIG. 13 illustrates VIS-PL emission spectra of glass MP7 under excitation 395 nm.

FIG. 14 illustrates VIS-PL emission spectra of glass MP8 under excitation 357 nm.

FIG. 15 illustrates NIR-PL emission spectra of glass MP8 under excitation 357 nm.

FIG. 16 illustrates Emission cross section of glass MP8.

FIG. 17 illustrates NIR-PL emission spectra of glass ninth embodiment MP9 under excitation 357 nm.

FIG. 18 illustrates Fluorescence decay lifetime level of glass MP2.

FIG. 19 illustrates Fluorescence decay lifetime level of glass MP2 (¹G₄ and ³H₄) and glass MP9 (¹G₄ and ³H₄).

FIG. 20 illustrates a fluorescence decay lifetime level of glass MP7 (⁵D₀) and glass MP9 (⁵D₀).

The figures depict embodiments of the present subject matter for the purposes of illustration only. A person skilled in the art will easily recognize from the following description that alternative embodiments of the methods illustrated herein may be employed without departing from the principles of the disclosure described herein.

### DETAILED DESCRIPTION

The best and other modes for carrying out the present invention are presented in terms of the embodiments, herein depicted in Drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

Unless otherwise defined, all technical and scientific terms used herein have the same meanings as commonly understood by those skilled in the art to which this invention belongs.

The system, method and examples provided herein are only illustrative and not intended to be limiting.

Embodiments of the present invention will be described below in detail with reference to the accompanying figures.

The present invention describes about fabricated glasses which has two basic oxide glasses P₂O₅ and TeO₂ and modifier oxide with halide ions F, Cl doped with the different rare earth and transition metal (Table 1).

A high rare earth doped glasses are more susceptible to crystallization during the fiber drawing reheating procedures. This work aims to improve their thermal stability as a production feature glass with low crystallization.

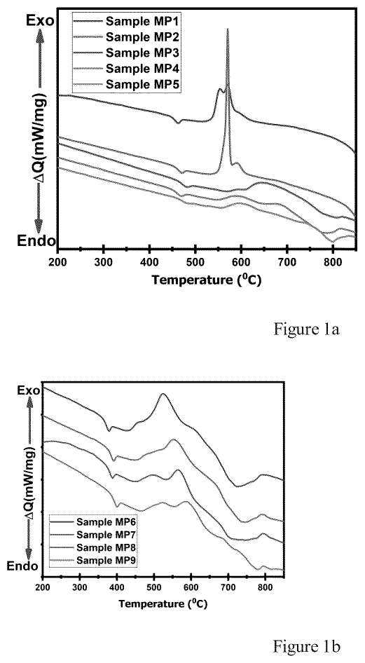

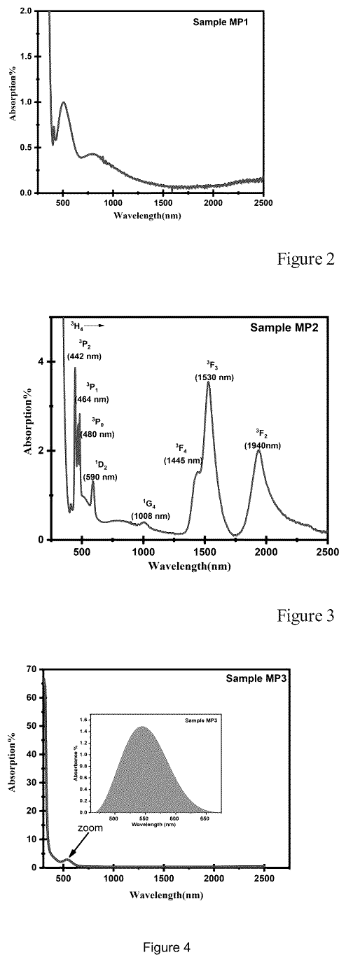

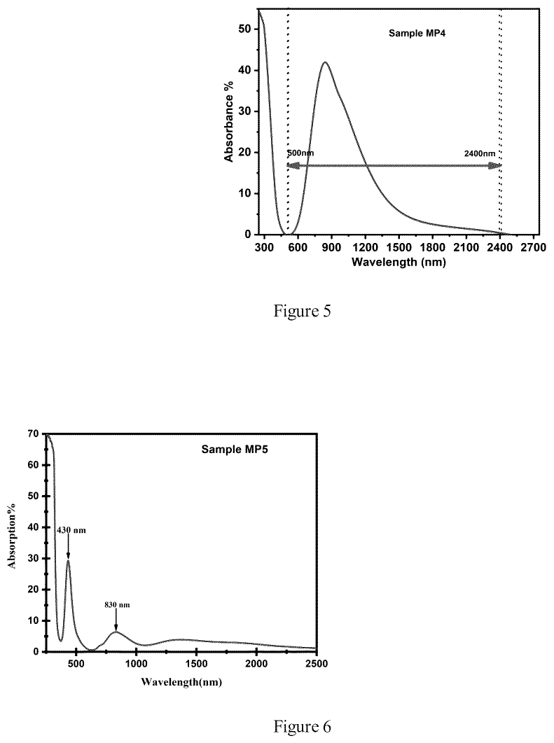

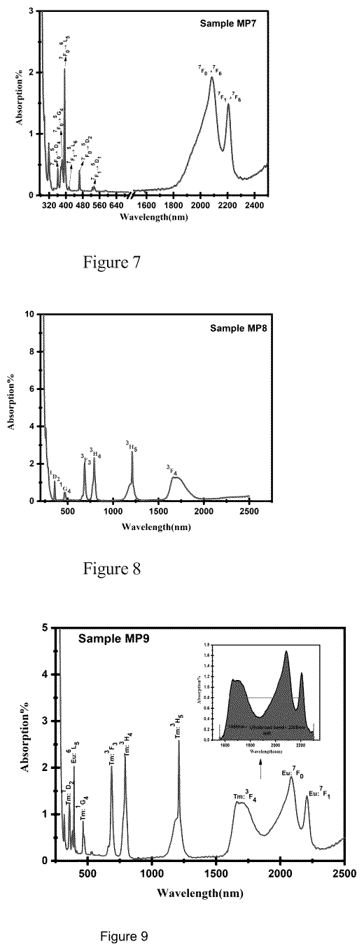

As illustrated in FIG. 1a, 1b, the DTA curves used to calculate the glass transition temperature (T_{g}), the start crystallization peak temperature (Tₓ), and the peak crystallization temperature (Tₚ) of the fabricated glasses. The thermal stability of the fabricated glasses are often measured using the criteria ΔT=Tₓ−T_{g}. When T is increased, anti-crystallization performance improves. When ΔT is increased, anti-crystallization performance improves. The results were obtained in Table 2, where the T_{g} is between 350 to 470° C., where the Tₓ is between 467 to 587° C., where the ΔT is between 110 to 138° C., and finally the Cₚ is between 0.131 to 0.361 J/mol·K. The large values of thermal stability indicates that fabricated glasses can possess a lower crystal nucleation with growth rate during the reheating process at fiber drawing. Furthermore, the fabricated glasses have suitable value of T_{g}, indicates a high ability against thermal damage.

The goal of this invention is to prepare a fabricated glasses dopped with copper oxide, which can be used as a candidate for a superior optical pass filter application from 500 to 2400 nm. Moreover, the fabricated glasses doped with nickel oxide acts as a narrow bandpass optical absorption filter, with a transmission band in the UV and red region.

The one embodiment of the present invention relates to fabricated glasses doped with Pr₂O₃ is particularly effective to provide high-power ASE sources that produce a broadband signal in the C and L bands. Hence, the fabricated glasses doped with Pr₂O₃ has a high phonon occupying the energy gap between the ³P₀ and ¹D₂ states leading to the emission of orange reddish colour. Moreover, the ¹D₂→¹G₄ transition occurred for the strong NIR luminescence band, which indicates that the broadband E-, S-, C-, and L-band amplification may be produced with success using these fabricated glasses.

In this invention the fabricated glasses contain halides LiCl and BaF₂ besides CdO to improve the ionic nature of host ion ligand to increase field strength of transition level of ³H₄→³F₄ to enhancing NIR emissions. The fabricated glasses doped with Tm₃₊ (MP8) and codoped with Tm3+/Eu3+ ions (MP9) to obtain much overlap between C-, S-, O-, and L optical bands for multichannel propagation and consequently it extending from 1.0 μm to 1.7 μm bands for amplification which desired to design media material with wide effective band of emission (Δλ_{eff}) for optical WDM communication fiber.

The fabricated glasses doped with Eu³⁺ ion which is an another embodiment, has intense brightness orangish red luminescence at 590-720 nm wavelength referring ⁵D₀→⁷F₂ transition. It used in LEDs and field emission technology which exhibit higher luminescence efficiency due to narrow monochromatic emitting around 610 nm and long radiative lifetime. This fabricated glasses are now used in treatment and clinical studies because it has maximal absorption areas of the photosensitizer.

The another embodiment of the present invention is the superior produced fabricated glasses codoped with Tm₂O₃/Eu₂O₃ produce ultra a broadband signal in the C and L bands 1530-2300 nm.

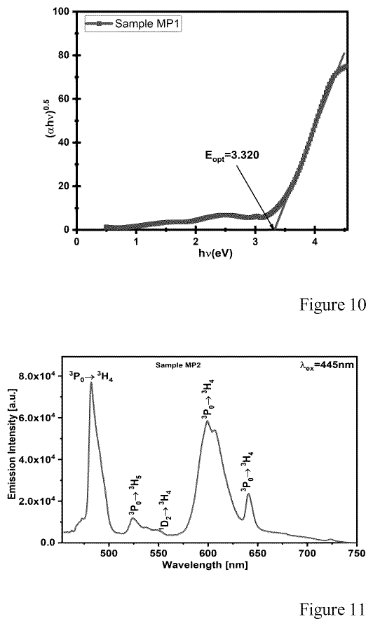

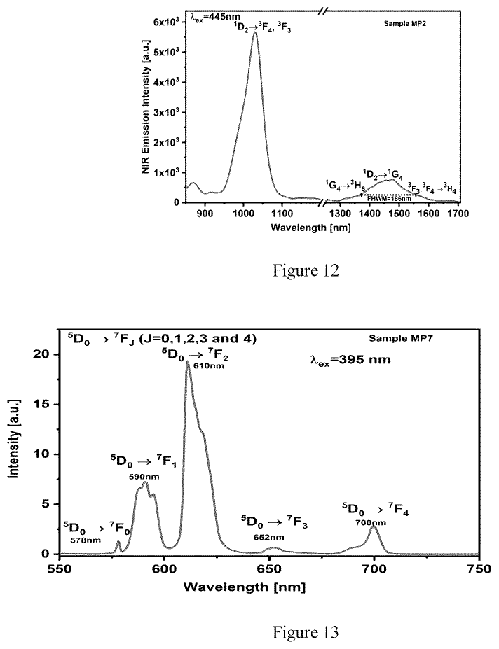

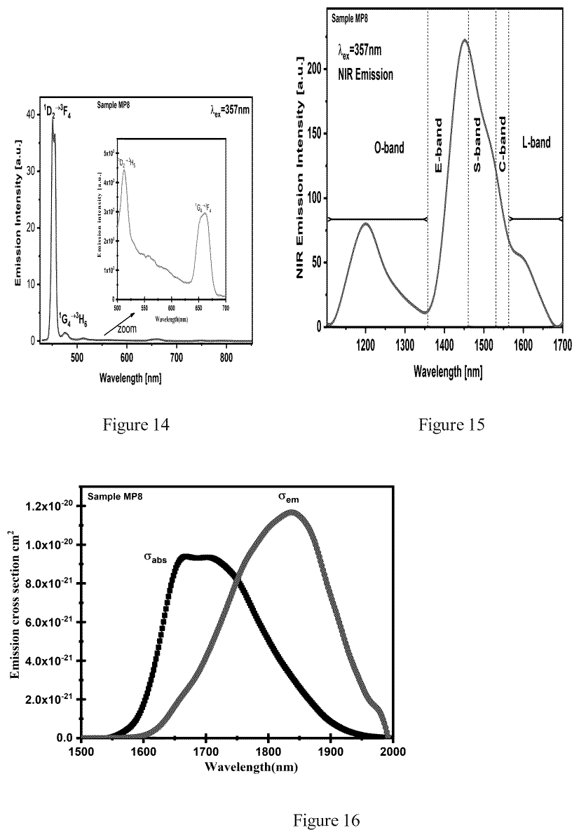

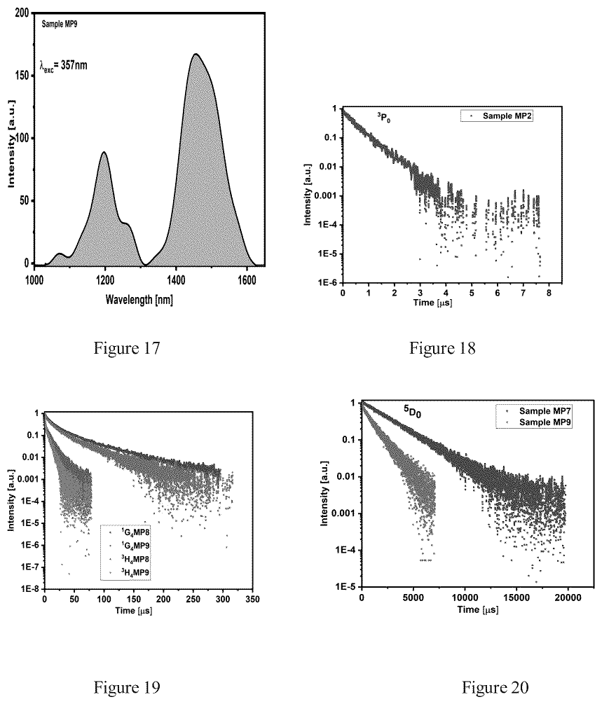

The value of the optical energy gap, Eₒₚₜ, is determined by using the absorption coefficient (α) and the photon energy (hv), which illustrates in FIG. 10. The results obtained that the value Eₒₚₜ is about (2.876 to 4.72 eV). The fabricated glasses MP4 with CuO has the lowest value other than the fabricated glasses MP6 doped with CdO has the highest value of Eₒₚₜ.

TABLE (1)
The compositions of produced samples.

| | First | Second | Third | Fourth | Fifth | Sixth | Seventh | Eighth | Ninth |
|---|---|---|---|---|---|---|---|---|---|
| | embodi- | embodi- | embodi- | embodi- | embodi- | embodi- | embodi- | embodi- | embodi- |
| | ment | ment | ment | ment | ment | ment | ment | ment | ment |
| | sample | sample | sample | sample | sample | sample | sample | sample | sample |
| | MP1 | MP2 | MP3 | MP4 | MP5 | MP6 | MP7 | MP8 | MP9 |
| P₂O₅ | 40 | 40 | 40 | 40 | 40 | 40 | 40 | 40 | 40 |
| ZnO | 35 | 35 | 25 | 25 | 25 | 30 | 30 | 30 | 30 |
| BaF₂ | 20 | 20 | 15 | 15 | 15 | 10 | 10 | 10 | 10 |
| MnO₂ | 3.0 | 3.0 | — | — | — | — | — | — | — |
| Ag₂O | 2.0 | 2.0 | — | — | — | — | — | — | — |
| Pr₂O₃ | — | 15000 ppm | — | — | — | — | — | — | — |
| Nb₂O₅ | — | — | 4.0 | 2.0 | 2.0 | — | — | — | — |
| TeO₂ | — | — | 15 | 15 | 15 | — | — | — | — |
| La₂O₃ | — | — | 1.0 | 1.0 | 1.0 | — | — | — | — |
| CuO | — | — | — | 2.0 | | — | — | — | — |
| NiO | — | — | — | — | 2.0 | — | — | — | — |
| LiCl | — | — | — | — | — | 18 | 18 | 18 | 18 |
| CdO | — | — | — | — | — | 2.0 | 2.0 | 2.0 | 2.0 |
| Eu₂O₃ | — | — | — | — | — | — | 35000 ppm | — | 35000 ppm |
| Tm₂O₃ | — | — | — | — | — | — | — | 35000 ppm | 35000 ppm |

TABLE (2)
Density, ρ, glass transition, T_{g}, onset crystallization
temperature, Tₓ, thermal stability, ΔT, specific heat, Cₚ, and
energy gap in eV, of produced glasses

| | | | | | | Energy |
|---|---|---|---|---|---|---|
| Glasses | Density | T_{g} | | | Cₚ | gap, Eₒₚₜ, |
| code | (gm/cm³) | (° C.) | Tₓ (° C.) | ΔT(° C.) | (J/gm · K) | in eV |
| Sample | 3.8597 | 445 | 555 | 110 | 0.161 | 3.320 |
| MP1 | | | | | | |
| Sample | 3.9215 | 457 | 568 | 111 | 0.131 | 3.319 |
| MP2 | | | | | | |
| Sample | 3.3273 | 460 | 587 | 127 | 0.163 | 3.32 |
| MP3 | | | | | | |
| Sample | 3.7508 | 470 | 586 | 116 | 0.136 | 2.876 |
| MP4 | | | | | | |
| Sample | 3.8542 | 460 | 591 | 131 | 0.134 | 3.45 |
| MP5 | | | | | | |
| Sample | 3.2573 | 350 | 467 | 117 | 0.268 | 4.749 |
| MP6 | | | | | | |
| Sample | 3.6046 | 355 | 476 | 121 | 0.237 | 4.236 |
| MP7 | | | | | | |
| Sample | 3.1259 | 400 | 512 | 112 | 0.361 | 4.663 |
| MP8 | | | | | | |
| Sample | 3.6251 | 382 | 520 | 138 | 0.205 | 4.209 |
| MP9 | | | | | | |

The present disclosure describes a UV-Vis-NIR absorption spectrum of fabricated glasses MP2 exhibits peaks relating to excited transitions between levels as follow; ³H₄ to ₃P² at (440 nm), ³H₄ to ³P₁ (466 nm), ³H₄ to ³P₀ (480 nm), ³H₄ to ¹D₂ (590 nm), ³H₄ to ¹G₄ (1008 nm), ³H₄ to ³F₄ (1445 nm), ³H₄ to ³F₃ (1530 nm), and ³H₄ to ³F₂ (1940 nm). Moreover, the highest transition peak refers to the excitation level ³F₃ but the lowest intensity is corresponded to level ¹G₄.

UV-Vis-NIR absorption spectrum of fabricated glasses MP7 exhibits peaks relating to excited transitions between ⁷F₀ to ⁵D₄ at (362 nm), ⁷F₀ to ⁵G₄ (381 nm), ⁷F₀ to ⁶L₅ (397 nm), ⁷F₁ to ⁵L₆ (414 nm), ⁷F₀ to ⁵D₂ (465 nm), ⁷F₁ to ⁵D₁ (533 nm), ⁷F₁ to ⁷F₆ (2080 nm), and ⁷F₁ to ⁷F₆ (2206 nm).

The UV-Vis-NIR absorption spectra of fabricated glasses MP8 exhibits peaks attribute to excited transitions levels from ³H₆→¹D₂ (356 nm), ³H₆→¹G₄ (470 nm), ³H₆+³F₃ (688 nm), ³H₆→³H₄ (787 nm), ³H₆→³H₅ (1210 nm) and ³H₆→³F₄ (1726 nm).

According to UV-Vis-NIR absorption spectra of fabricated glasses MP9, absorbance peaks corresponding to excited transitions such as; Tm:¹D₂ (355 nm), Eu:⁶L₅ (395 nm), Tm:¹G₄ (462 nm), Tm:³F₃ (689 nm), Tm:³H₄ (795 nm), Tm:³H₅ (1209), Tm:³F₄ (1725 nm), Eu:⁷F₀ (2082 nm) and Eu:⁷F₁ (2210 nm).

The PL emission spectra of fabricated glasses MP2 at λ_{excitation}=445 nm obtains that emission occurred at transition level as follow; ³P₀→³H₄ (480 nm), ³P₀→³H₅ (520 nm), ¹D₂→³H₄ (552 nm), ³P₀→³H₆ (605 nm) and ³P₀→³F₂ (642 nm). The fabricated glasses MP2—has luminescence blue emission and reddish orange. The peaks emission spectrum obtained according to ³P₀→³H₄ (blue) and ¹D₂→³H₄/³P₀→³H₆ (red/orange).

The NIR emission spectra of fabricated glasses MP2 at excited by wavelength 445 nm, the transition peaks obtain transition levels as follow; ¹D₂→³F₃, ³F₄, ¹G₄→³H₅ and ¹G₄→³H₅ for optical fiber amplifiers functioning within the second transmission telecommunication window. The ultra broadband near-infrared with FWHM=186 nm for the equivalent transition emission fluorescence leads to the fabricated glasses MP2 are well suitable for fabrication of optical fibre amplification covering the E-, S-, C-, and L-band.

There is a spectra emission for the another embodiment of the fabricated glasses MP7 at room temperature. The spectra show an increase in emission intensity with Eu₂O₃ content for all samples studied. The emission spectra consist of the bands ⁵D₀ to ⁷F_{J} (where J=0, 1, 2, 3, and 4) transitions, refer as ⁵D₀ to ⁷F₀ (580 nm), ⁵D₀ to ⁷F₁ (592 nm), ⁵D₀ to ⁷F₂ (614 nm), ⁵D₀ to ⁷F₃ (654 nm) and ⁵D₀ to ⁷F₄ (704 nm), attributed to Eu³⁺ ions. Intense luminescence orangish red emissions were established in fabricated glasses MP7.

The PL emission features of fabricated glasses MP8 doped with Tm³⁺ ions which is another embodiment of the present invention, exhibit at excitation wavelength 357 nm obtains four bands emission as follows:
two in blue ¹D₂→³F₄ (450 nm) and ¹G₄→³H₆ (476 nm),
green ¹D₂→³H₅ (520 nm), and
red ¹G₄→³F₄ (660 nm)

These regions are peaked at 450 nm, 476 nm, 520 nm, and 660 nm. The intensity of the emission transition for transition (¹G₄→³H₆, ¹D₂→³H₅, and ¹G₄→³F₄) are low comparison with ¹D₂→³F₄ transition intensity, but the blue emission at 450 nm is very high intensity. The fabricated glasses MP8 exhibits high peak emission cross-section σₘₐₓ^{em}×Δλ_{eff}=10.4×10⁻²⁶ cm³ and gain bandwidth σₘₐₓ^{em}×τ_{rad}=19.8×10⁻²⁶ cm²s for transition ¹D₂→³F₄ to produce blue laser emission process.

The NIR luminescence spectra of fabricated glasses MP8 are in the range 1100-1700 nm range under λₑₓ=357 nm. A wide NIR emission band from 1350 to 1700 nm is reported. The transition ³F₄→³H₆ (˜1.8 μm) NIR emission has not observed because of the detector sensitivity measured up to 1700 nm. The halides ions F and Cl improve the host-ion ligand's ionic nature leading to increased field strength. As a result, the transition ³H₄→³F₄ obtains stark splitting enhancing NIR emissions broadening further. So ³H₄→³F₄ transition is boarding from 1.35 μm to 1.7 μm E-+S-+C-+L bands for amplification with wide Δλ_{eff}=141 nm for optical WDM communication window. The advantage of wideband fiber amplifiers can operate in the NIR emission and the gained emission pattern will be shift to longer NIR wavelengths leads to covering C and L band. Hence, the fabricated glasses MP8 is improved and covers most of communication channels, WDM systems with greater gain bandwidths often have a lower total cost.

The maximum emission cross section, σₘₐₓ^{em} values at 1.45 μm for fabricated glasses evaluated is equal to 1.18×10⁻²⁰ cm² with Δλ_{eff}=141.7 nm, whereas mixed alkali oxides BaF₂ and LiCl improved effective amplification within identified wide spectral range. The fabricated glasses MP8 with largest σₘₐₓ^{em}×Δλ_{eff}, and σₘₐₓ^{em}×τ_{rad} values specify the chances of effective amplification within identified wide spectral range are equal to 16.7×10⁻²⁶ cm³ and 35.75×10⁻²⁶ cm²s respectively.

Finally the Tm³⁺/Eu³⁺ doped with fabricated glasses MP9 is the another embodiment of the present invention. This can release high intense blue and orangish-red fluorescence strongly depend on the excitation wavelength will be used in the medical diagnostic as solid laser source. It has absorption regions attributed to the photosensitizer material which employed in photodynamic therapy (PDT) and clinical treatment. Moreover, this fabricated glasses are suitable for fiber amplifier in L ultrabroad band signal communication between 1530-2300 nm. Stronger fluorescence emission of RE ions is produced due to the presence of fluoride and chloride ions in fluorophosphate glasses, which also effectively lowers the presence of hydrogen and hydroxyl ions.

In the present invention we determine the lifetime values of fabricated glasses by using τₑₓₚ=∫tε(t)/ε(t). The radiative lifetime, estimated for fabricated glasses as follow:
τₑₓₚ=20 μs of ¹G₄ transition level for MP8,
τₑₓₚ=14.5 μs of ¹G₄ transition level for MP9,
τₑₓₚ=3.03 μs of ³H₄ transition level for MP8,
τₑₓₚ=2.0 μs of ³H₄ transition level for MP9,
τₑₓₚ=0.51 μs of ³P₀ transition level for MP2,
τₑₓₚ=25.9 μs of ⁵D₀ transition level for MP7 and
τₑₓₚ=9.8 μs of ⁵D₀ transition level for MP9.

### TECHNICAL ADVANTAGES

The main advantage of the present invention is that the proposed device and process is first of its kind to facilitate separation and detection of MPs in water sample.
Another advantage of the proposed device is that it requires less power to operate which enable it sportability.
Still another advantage is to facilitate faster detection than the current methods of analysis.
Yet another advantage is that it does not require highly skilled technicians to operate the device.

We claim:

1. A fabricated glass comprising:
phosphorus pentoxide by weight of composition 40 percentage;
barium fluoride by weight of composition ranging from 25-35 percentage;
zinc oxide by weight of composition ranging from 10-20 percentage; and
remaining are one or more additives selected from the group of Manganese dioxide, Silver oxide, Praseodymium oxide, Niobium pentoxide, Tellurium dioxide, Lanthanum (III) oxide, Copper (II) oxide, Nickel oxide, Lithium Chloride, Cadmium oxide, Europium (III) oxide, and Thulium (III) oxide

2. The glass as claimed in claim 1, wherein the additive is selected as Manganese dioxide and Silver Oxide, such that the fabricated glass has 3 percentage of Manganese dioxide and 2 percentage of Silver oxide, wherein the fabricated glass is doped with the Manganese dioxide.

3. The glass as claimed in claim 1, wherein the additive is selected as Praseodymium oxide, such that the fabricated glass has 15000 parts per million of Praseodymium, wherein the glass is doped with the Praseodymium oxide.

4. The glass as claimed in claim 1, wherein the additive is selected as Niobium pentoxide, Tellurium dioxide and Lanthanum (III) oxide, such that the fabricated glass has Niobium pentoxide ranging 2-4 percentage, 15 percentage of Tellurium dioxide and 1 percentage of Lanthanum (III) oxide, wherein the glass is dopped with the Lanthanum (III) oxide

5. The glass as claimed in claim 1, wherein the additive is selected as Copper (II) oxide, such that the fabricated glass has 2 percentage of Copper (II) oxide, wherein the glass is doped with Copper (II) oxide.

6. The glass as claimed in claim 1, wherein the additive is selected as Nickel Oxide, such that the fabricated glass has 2 percentage of Nickel oxide, wherein the glass is doped with Nickel oxide.

7. The glass as claimed in claim 1, wherein the additive is selected as Lithium Chloride and Cadmium oxide, such that the fabricated glass has 18 percentage of Lithium Chloride and 2 percentage of Cadmium oxide, wherein the glass is doped with Cadmium oxide.

8. The glass as claimed in claim 1, wherein the additive is selected as Europium (III) oxide, such that the fabricated glass has 3500 parts per million of Europium (III) oxide, wherein the glass is doped with Europium (III) oxide.

9. The glass as claimed in claim 1, wherein the additive is selected as Thulium (III) oxide, such that the fabricated glass has 3500 parts per million of Thulium (III) oxide, wherein the glass is doped with Thulium (III) oxide.
